(19) United States
(12) Patent Application Publication
(10) Pub. No.: US 2011/0037202 A1
(43) Pub. Date: Feb. 17, 2011

(54) METHOD AND DEVICE FOR SPINNING OF POLYMER MATRIX IN ELECTROSTATIC FIELD

(76) Inventors: Ladislav Sevcik, Liberac (CZ); Jan Cmelik, Liberac (CZ); Radek Sladecek, Knezmost (CZ)

Correspondence Address: OSTROLENK FABER GERB & SOFFEN, 1180 AVENUE OF THE AMERICAS, NEW YORK, NY, 100368403, US

(21) Appl. No.: 12/936,523

(22) PCT Filed: Apr. 3, 2009
(86) PCT No.: PCT/CZ09/00046

§ 371 Date: Oct. 29, 2010

(30) Foreign Application Priority Data
Apr. 9, 2008 (CZ) PV2008-218

(51) Int. Cl. B29C 47/00

(52) U.S. Cl. 264/465; 425/174.8 E

(57) ABSTRACT

The present disclosure relates to the method for spinning of polymer matrix in an electrostatic field induced in a spinning space between a spinning electrode and a collecting electrode, at which the polymer matrix is delivered from a matrix reservoir into the electrostatic field on surface of the spinning electrode or by the spinning elements of the spinning electrode, whose principle consist in that the temperature of the spinning electrode or spinning elements of the spinning electrode, and/or reservoir, and/or of polymer matrix is increased above the surrounding temperature by means of resistance heating. The disclosure further relates to the device for performing of this method.

### TECHNICAL FIELD

The invention relates to the method for spinning of polymer matrix in electrostatic field induced in the spinning space between a spinning electrode and a collecting electrode, at which the polymer matrix is delivered from matrix reservoir into the electrostatic field on surface of the spinning electrode or by spinning elements of the spinning electrode.

The invention further relates to a device for production of nanofibres through electrostatic spinning of polymer matrix in electrostatic field induced between the collecting electrode and the spinning electrode or spinning elements of the spinning electrode.

### BACKGROUND ART

At present the polymer nanofibres are produced through electrostatic spinning of various types of solutions and melts of polymers in liquid state, which usually runs at the surrounding temperature. In some cases, especially at spinning of melts of polymers, it is necessary to increase the temperature of some parts of the device in order to ever prepare the melt and to avoid its solidification and its fixation on these parts, which would gradually reduce the output of the whole device. Temperature increasing of these parts is also advantageous at spinning of some types of polymer solutions, because the increased temperature reduces viscosity of these solutions, through which initialization and maintaining of electrostatic spinning process is supported, and in case of some types of polymer solutions it even enables their spinning.

At present, such warming-up is realised above all by means of heat-carrying media, for example by a hot air or hot oil, nevertheless the heat transfer is in these cases very loosing, and the necessity of circulation of heat-carrying media relatively markedly restricts the shape of inner space of the device for electrostatic spinning and arrangement of its individual parts. The means for warming-up and circulation of the heat-carrying media, and in case of oil or other liquid also the means for their storage, relatively markedly increase not only the space demands of these devices, but also the requirements for their maintenance and simultaneously also the acquisition and operational costs of these devices. Another disadvantage is a low accuracy of temperature regulation and its slow response.

Another way of warming-up is also an induction heating of polymer matrix in the reservoir, at which the induction heating plate is positioned in the area under the reservoir. Nevertheless this configuration besides relatively high temperature loss and high demand on space, also shows a slow response when temperature change of polymer matrix in reservoir is required, as well as inaccuracy of setting this temperature.

The goal of the invention is to secure an easy adjustable, temporary or permanent increase of temperature of some parts of the device for production of nanofibres through electrostatic spinning, especially of those which are in contact with polymer matrix, by another method than the methods known from background art, which would be more efficient and structurally more simple.

The goal of the invention is also the device for production of nanofibres through electrostatic spinning of polymer matrix using this method for increasing of temperature of some parts.

### PRINCIPLE OF THE INVENTION

The goal of the invention has been achieved by the method of spinning of polymer matrix in electrostatic field induced in a spinning space between a spinning electrode and a collecting electrode, at which the polymer matrix is delivered from the matrix reservoir into electrostatic field on surface of the spinning electrode or by the spinning elements of spinning electrode, whose principle consists in that, during it the temperature of some parts of the device is increased, especially of those parts which are in contact with polymer matrix, e.g. of the spinning electrode or of the spinning elements of the spinning electrode and/or of reservoir and/or of polymer matrix, by a direct resistance heating above the surrounding temperature.

Temperature of these parts is with advantage increased by a direct resistance heating by an alternating voltage, which is brought directly to the part whose temperature should be increased, while it is at the same time transformed into a thermal energy. Thus, the condition is electrical conductivity of these parts.

Another method for increasing the temperature of required parts of the device for production of nanofibres is a direct resistance heating by means of a direct voltage, when the particular part is connected to a source of high direct voltage and with auxiliary source of high direct voltage, whose voltage differs by value of tens or hundreds of volts, while the nominal difference of these voltages is, after being brought to the given part, transformed into a thermal energy. This method is applicable especially at mobile applications, when the source of high voltage of direct current is better available than the source of, alternating voltage.

In the case if it is not possible to bring to some part directly the alternating voltage or two direct voltages of various values, e.g. due to non-conductivity of this part, then there is advantageous the variant of indirect resistance heating, when in the vicinity of the part whose temperature should be increased, the heating resistor connected to source of alternating voltage is positioned. The alternating electric voltage is transformed to thermal energy in this resistor, and this is further transmitted to the required part.

The goal of the invention has also been achieved by a device for production of nanofibres through electrostatic spinning of polymer matrix in electrostatic field induced between the collecting electrode and spinning electrode or the spinning elements of spinning electrode, whose principle consists in that the spinning electrode and/or the spinning elements of the spinning electrode are connected to the secondary winding of transformer, which is insulated for a high voltage, while the primary winding of this transformer is connected to source of alternating voltage. Through this manner is by this device secured transfer of alternating voltage to that part of this device whose temperature should be increased, and simultaneously insulation of parts with high direct voltage from source of alternating voltage.

Next to this, the goal of the invention has been achieved by the device for production of nanofibres through electrostatic spinning of polymer matrix in the electrostatic field induced between the collecting electrode and the spinning electrode or the spinning elements of the spinning electrode, while the spinning electrode or the spinning elements of spinning electrode are connected to one pole of the source of high voltage of direct current, whose principle consists in that the spinning electrode or the spinning elements of the spinning electrode are connected to auxiliary source of direct voltage. The difference of voltage delivered by the source of high voltage of direct current and by the auxiliary source of high voltage of direct current is after delivery to the given part transformed into the thermal energy.

It is advantageous, especially for spinning of melts of polymers, if some parts of the device are connected to the source of alternating voltage or to the auxiliary source of direct voltage, and in the electrostatic field there is further arranged at least one heating resistor, which is connected to secondary winding of transformer, which is insulated for high voltage, while the primary winding of the transformer is connected to the source of alternating voltage. Thus, the heating resistor serves for indirect resistance heating of parts positioned in the electrostatic field, whose temperature cannot be increased by a direct resistance heating or it would be too complicated as regards the construction.

### DESCRIPTION OF THE DRAWING

Example of the device for performance of the method of electrostatic spinning of polymer matrix according to the invention is schematically represented in the attached drawing, where the

FIG. 1 shows a cross section through the spinning chamber of this device, the

FIG. 2 a cross section of the spinning chamber of another variant of this device.

### EXAMPLES OF EMBODIMENT

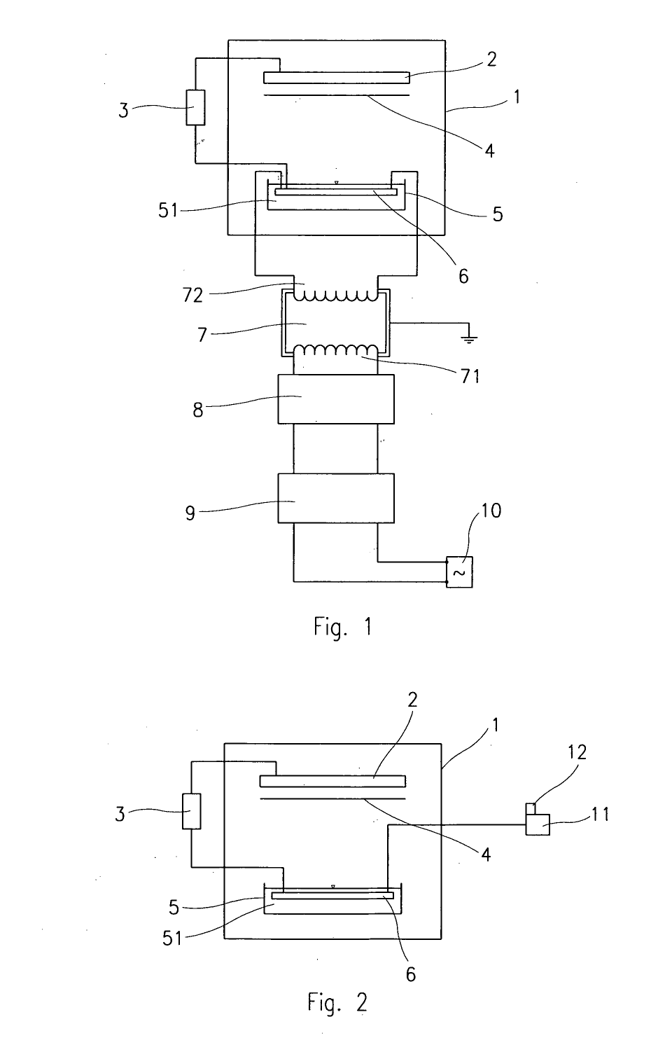

The invention and its principle shall be described on examples of embodiment of the device for electrostatic spinning of polymer matrices, which are schematically represented in the FIG. 1 and FIG. 2. For the purpose to increase transparency and readability of these drawings, some parts of the device are represented only in a simplified way regardless their real structure or dimensions, while some other parts, that are not essential for understanding to the principle of the invention and whose structure or the mutual arrangement are obvious to each person skilled in the art, are not represented at all.

The device for electrostatic spinning of polymer matrix represented in the FIG. 1 comprises the spinning chamber 1, in upper part of which there is arranged the collecting electrode 2, which is connected to one pole of source 3 of high voltage of direct current, which is positioned outside the spinning chamber 1. The represented collecting electrode 2 is formed of a metal plate, nevertheless in another not represented examples of the embodiment according to technological requirements or spatial possibilities there may be used any other known construction of collecting electrode 2, possibly several collecting electrodes 2 of any type, or their combinations.

Under the collecting electrode 2 an electrically non-conducting substrate 4 is transported by not represented means, which in the represented example of embodiment is a fabric. Particular type of substrate 4, manner of its motion and its physical properties like e.g. electrical conductivity, nevertheless depend first of all on the type of used collecting electrode 2 and production technology, while in further not represented examples of embodiment may be as a substrate 4 used also electrically conductive materials, like e.g. the fabric with electrostatic surface finish, metallic foil, etc. At usage of special type of the collecting electrode, known e.g. from the CZ PV 2007-727, on the contrary the substrate 4 is not used at all, and the nanofibres produced through electrostatic spinning of polymer matrix are deposited directly on surface of this collecting electrode.

In lower part of the spinning chamber 1 there is arranged reservoir 5 of polymer matrix 51, which is in the represented example of embodiment formed of opened vessel, while the polymer matrix 51 is a polymer solution in liquid state. In another, not represented examples of embodiment, utilising the principle of the invention, it is possible to subject to spinning also melts of polymers or suitable polymer matrices 51 in solid state, to which further corresponds variations in construction of the reservoir 5 and of the not represented means for adding polymer matrix 51 into it.

In vicinity of the reservoir 5 there is positioned the spinning electrode, comprising the spinning element 6, connected to opposite pole of source 3 of high voltage of direct current than the collecting electrode 2, while the spinning element 6 is displaceable between its applying position and its spinning position in adjustable intervals. In an applying position the spinning element 6 or its section is distanced from the collecting electrode 2, and polymer matrix 51 is applied on it, while in spinning position the spinning element 6 or its portion with applied polymer matrix 51 is approached to the collecting electrode 2, where together with it creates the electrostatic spinning field, by means of which this polymer matrix 51 is subjected to spinning. The FIG. 1 represents the spinning element 6 formed of electrically conductive wire, which is in its applying position immersed under the level of polymer matrix 51 in the reservoir 5, and which displaces between its spinning position and its applying position in both directions reversibly in a plane. Nevertheless the principle of the invention is without any further changes also applicable for other known structures of the spinning elements 6 of spinning electrodes, which e.g. according to the CZ PV 2006-545 displace between their spinning position and their applying position on a circular trajectory, or according to the CZ PV 2007-485 in direction of their length.

The spinning element 6 is besides the source 3 of high voltage of direct current conductively connected to the secondary winding 72 of transformer 7, which is insulated for high voltage. The primary winding 71 of the transformer 7 is through the regulator 8 and overvoltage protection 9 connected to the source 10 of alternating voltage, which is for example the public distribution network of alternating voltage of 230V. The transformer 7 serves at the same time for galvanic separation of the source of alternating voltage 10 from the spinning element 6, to which is supplied a high voltage of direct current having value of tens of kilovolts, because thanks to the principle of its function it enables transformation of alternating voltage supplied into its primary winding 71 into alternating voltage induced in secondary winding 72, but not transformation of high voltage of direct current supplied from the spinning element 6 to its secondary winding 72. The ratio of number of windings in the primary winding 71 and the secondary winding 72, and value of voltage supplied to the primary winding 71 simultaneously determine the value of alternating voltage supplied to the spinning element 6 of the spinning electrode, so that nearly for any required value of alternating voltage may be as a source 10 of low alternating voltage used e.g. the public network with constant value of alternating voltage and adequately dimensioned transformer 7.

Electric input of alternating voltage supplied to the spinning element 6 of the spinning electrode changes in dependence on its electric resistance, for example according to the equation P=UI=RI²=U²/R to so called Joule-Lence heat, and increases temperature of the spinning element 6.

The required temperature of the spinning element 6 then may be simply adjusted by regulator 8 regulating the value of the alternating voltage supplied from the source 10 into the primary winding 71 of the transformer 7, thus adequately also the value of alternating current induced on its secondary winding 72. In the not represented example of embodiment the regulator 8 is with advantage additionally equipped with feedback, which enables more accurate and quicker achievement of desired temperature of the spinning element 6 and its long-term maintaining on a constant value. Overvoltage protection 9 protects the transformer 7 and the spinning elements 6 of the spinning electrode against step changes in output of the source 10 of the alternating voltage. Another protective element is grounding of core of the transformer 7.

Temperature increase of the spinning elements 6 of the spinning electrode brings advantages especially at spinning of polymer matrix 51 formed of melt of polymer, because it supports remaining of melt volume in the reservoir 5 or volume of the melt 51 applied on the spinning element 6 in liquid state for a period necessary for its spinning, by which the applicability of these types of polymer matrices 51 is for electrostatic spinning increased, as well as its efficiency. Next to this, at a suitable selection of temperature of the spinning element 6 the solid polymer matrices 51 may be subjected to spinning, while only a small portion of its volume is brought into the liquid state upon contact with the spinning element 6, and at the same time it sticks to the surface of the spinning element 6 and consequently is subject to spinning. Through this there are limited the thermal losses, which occur upon maintaining the whole volume of melt of polymer in a liquid state, and simultaneously the problems with undesired solidifying of melt in reservoir 5 are eliminated.

In further examples of embodiment on the contrary the principle of the invention may also be used for increasing the temperature of the reservoir 5 and/or directly of polymer matrix 51 and its maintaining in liquid state throughout whole working cycle of the device.

Increasing of temperature at spinning of some polymer solutions reduces their viscosity, which facilitates initialization of the process of electrostatic spinning. Increasing of temperature thus not only leads to increase of output of the whole device, but it also enlarges the platform of spinnable solutions, as it enables and makes easier spinning of such polymer solutions, which were to date spinnable only with difficulties or not at all.

The FIG. 2 represents a further possibility of electric linkage, enabling increase of temperature of the spinning element 6 of spinning electrode, when from the source 11 of auxiliary voltage a high voltage of direct current is supplied to it. Value of this voltage is slightly different from the value of voltage supplied to the spinning element from the source 3 of a high voltage of direct current, while the difference of these voltages expressed in tens or hundreds of volts changes after supplying to the spinning element 6 to the thermal output, thus increases its temperature. Temperature of the spinning element 6 is after then controlled by means of regulator 12 of output of the source 11 of auxiliary high voltage of direct current. Regulator 12 is in a not represented example of embodiment preferably provided with feedback.

Thanks to electrical conductivity of polymer matrix 5 the high voltage of direct current from the auxiliary source 11 may be utilised directly also for increasing of temperature of the matrix 5, and in case of application of electrically conductive reservoir 51, also for direct increasing of its temperature, which further supports and increases above described advantages.

In other not represented examples of embodiments, when for example the spinning element 6 of spinning electrode is made of electrically non-conducting material, for increasing of its temperature a utilisation of a non-direct heating by means of alternating current is more advantageous. In such a case in a vicinity of each spinning element 6 of spinning electrode or at least on a section of its trajectory, in the case it moves during the spinning process, is positioned one or according to need more heating resistors, which are upon utilisation of the above mention transformer 7 connected to the source 10 of alternating voltage. Alternating current is transformed into Joule-Lence heat directly in heating resistors, and this is transferred to the spinning element 6. The same method of indirect heating may also be utilised for heating of the reservoir 5 and/or of polymer matrix 51 in it.

The direct as well as indirect resistance heating may also be, next to the above mentioned variants of the device for production of nanofibres, utilised also at other known and generally used devices, in principle regardless the type and structure of the spinning electrode 2. Principle of the invention may be utilised for example for heating of the spinning electrode formed of a compact body known from the CZ patent 294274, or of the spinning electrodes formed of capillary (nozzle), or a group of capillaries (nozzles), at any configuration of polarities of direct voltage on the collecting electrode 2 and spinning electrode or spinning elements 6 of the spinning electrode. Indirect heating, or heating by means of direct voltage may also be utilised at grounding of the spinning electrode or of its elements 6, regardless the polarity of voltage supplied to the collecting electrode 2.

### LIST OF REFERENTIAL MARKINGS

1 spinning chamber
2 collecting electrode
3 source of high voltage of direct current
4 substrate
5 reservoir
51 polymer matrix
6 spinning element
7 transformer
71 transformer primary winding
72 transformer secondary winding
8 regulator
9 overvoltage protection
10 source of alternating voltage
11 source of auxiliary high voltage of direct current
12 regulator

1. The method for spinning of polymer matrix in an electrostatic field induced in a spinning space between a spinning element of the spinning electrode, which is connected to one pole of a source of high voltage, and which is in its spinning position, and a collecting electrode, which is connected to the second pole of the source of high voltage, at which the polymer matrix is delivered from a reservoir of the polymer matrix into the electrostatic field for spinning on surface of the spinning element of the spinning electrode, wherein the temperature of the spinning elements of the spinning electrode is increased above the surrounding temperature by means of a direct resistance heating of the spinning elements.

2. The method according to claim 1, wherein the temperature of polymer matrix and/or reservoir of polymer matrix is simultaneously increased by means of a direct resistance heating.

3. The method according to claim 1, wherein the temperature is increased by a direct resistance heating by an alternating voltage, which is supplied from the secondary winding of a transformer which is insulated for a high voltage, while the primary winding of the transformer is connected to a source of low alternating voltage.

4. The method according to claim 1, wherein the temperature is increased by a direct resistance heating by an auxiliary high direct voltage from an auxiliary source of direct voltage, while the value of the auxiliary high direct voltage from the auxiliary source is different from the value of high voltage supplied to the spinning element from the source of high voltage.

5. The device for production of nanofibres through electrostatic spinning of polymer matrix in the electrostatic field induced between the spinning element of spinning electrode, which is connected to one pole of the source of high voltage and which is in its spinning position, and a collecting electrode, which is connected to the second pole of the source of high voltage, wherein the spinning elements of the spinning electrode are simultaneously connected to secondary winding of transformer, which is insulated for a high voltage, while the primary winding of the transformer is connected to source of alternating voltage.

6. The device according to claim 5, wherein the transformer is with the source of alternating voltage connected through an overvoltage protection and a regulator.

7. The device for production of nanofibres through electrostatic spinning of polymer matrix in electrostatic field induced between the spinning element of spinning electrode, which is connected to one pole of the source of high voltage of direct current, and which is in its spinning position, and a collecting electrode, which is connected to the second pole of the source of high voltage, wherein the spinning elements of the spinning electrode are simultaneously connected to auxiliary source of high direct voltage, while the value of auxiliary high voltage from the source is different from value of high voltage supplied to the spinning element from a source of high voltage.

8. The device according to claim 5, wherein the spinning element of the spinning electrode is formed of electrically conductive wire.
